(19) United States
(12) Patent Application Publication
(10) Pub. No.: US 2008/0213640 A1
(43) Pub. Date: Sep. 4, 2008

(54) Closed Loop Electrical Energy Source

(76) Inventors: Deidre Jeanne Mazzoni, Hillsborough, NC (US); Donald J. Adams, Englewood, FL (US)

Correspondence Address: Deidre Mazzoni, 1315 Hounds Ear Rd, Hillsborough, NC, 27278, US

(21) Appl. No.: 12/040,903

(22) Filed: Mar. 2, 2008

Related U.S. Application Data
(60) Provisional application No. 60/904,421, filed on Mar. 2, 2007.

(51) Int. Cl. H01M 8/06

(52) U.S. Cl. 429/19

(57) ABSTRACT

This claim uses current water to hydrogen conversion technology. By connecting the hydrogen converter to a water reservoir, a hydrogen fuel cell, and a water pump in a well-designed container a closed loop energy source can be created.

The exhaust (water) from the fuel cell is collected and pumped back into the reservoir for continuous water to hydrogen conversion. The pump is powered internally creating a closed loop.

Some amount of water loss will eventually occur even in a closed environment. The water reservoir will include an alarm level indicating when it needs additional water. Depending on the unit size, additional water may need to be added somewhere between every 1-5 years.

The intended use of this design is to replace electrical output sources of all sizes. Minor modifications to allow direct output of hydrogen, instead of conversion to electricity, will allow this closed unit to also replace gas/oil heaters.

### CROSS-REFERENCE TO RELATED APPLICATIONS

Provisional Patent Application:
Appl No. 60/904,421
File Date Mar. 2, 2007
Docket # 1201-DJM
Confirmation #: 9668

### STATEMENT REGARDING FEDERALLY SPONSORED RESEARCH OR DEVELOPMENT

Not Applicable

### BACKGROUND OF THE INVENTION

This invention pertains to the endeavor to create a clean, renewable energy source that is scalable and flexible enough to meet a variety of energy needs and uses. The problem with current clean energy sources is that they do not take advantage of the exhaust from the energy source. When the input (fuel) into the energy system is the same as the exhaust from the energy output, the opportunity exists for a closed loop, recycling situation that will extend and expand the energy output capacity, with significantly less input (fuel). This is most evident with the hydrogen fuel cell. Hydrogen is created from water, and the exhaust from the fuel cell is water. Both the input (initial fuel) and the output (exhaust) are the same. BRIEF SUMMARY OF THE INVENTION

The objective of this claim is that multiple existing elements can be brought together into a single contained system to create a versatile, scalable, close loop energy source.

The system is a single unit containing a water reservoir. To operate the unit a temporary power source starts the water-to-hydrogen converter. The hydrogen flows into two separate fuel cell areas. The first cell will power the compact converter, relieving the temporary power source, and also power a water pump in the exhaust collection container, moving the water by-product from the fuel cell back into the water reservoir that is feeding the water-to-hydrogen converter. The second and larger cell will produce the energy output (either electrical power or pure hydrogen).

The intended use of this closed loop system is to replace electrical output sources from small, temporary generators to entire electrical power plants servicing major cities. Or, with the direct output of hydrogen, replace gas/oil energy systems, including vehicles.

### BRIEF DESCRIPTION OF THE SEVERAL VIEWS OF THE DRAWING

FIG. 1—High level diagram of the Closed Loop Electrical Energy Output Source showing the working concept of the claim

FIG. 2—Diagram of the Closed Loop Electrical Energy Output Source depicting calculations and considerations for scalability and reservoir size.

### DETAILED DESCRIPTION OF THE INVENTION

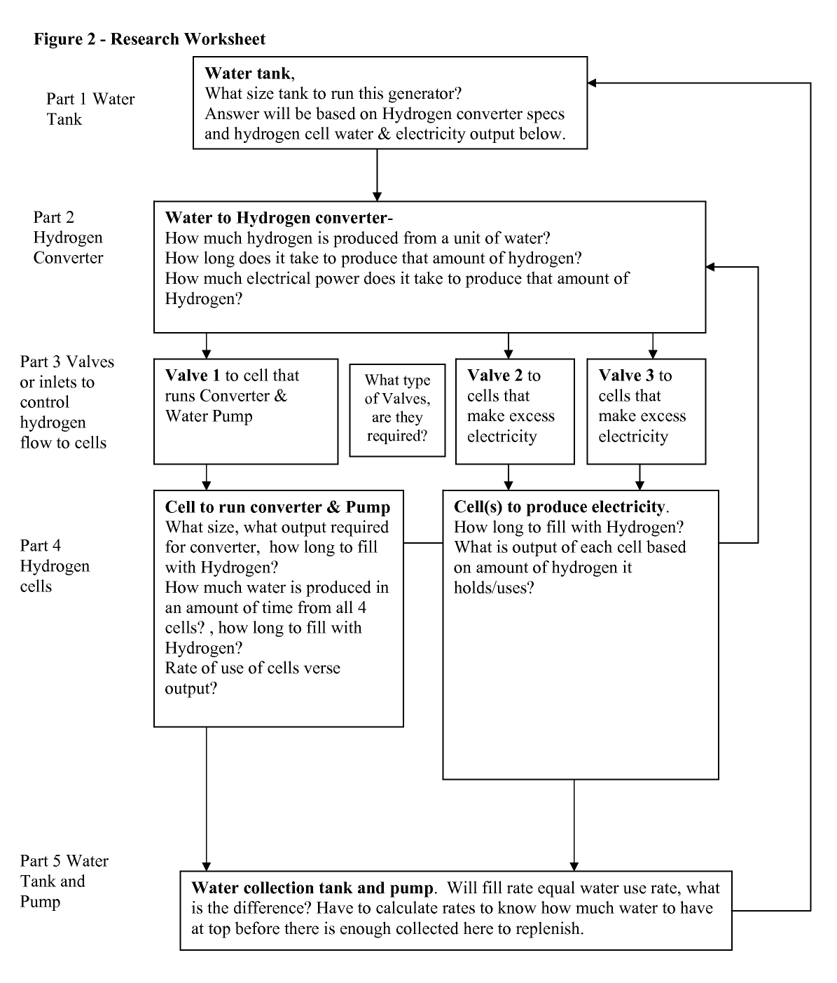

There are at least two different compact water-to-hydrogen converters currently in operation available for use in the unit. One is being used in vehicles to allow them to run on water converted to hydrogen. The second is currently used in a hydrogen burning fireplace. By connecting the hydrogen converter to a hydrogen fuel cell and adding a collection/pump mechanism to collect and recycle the water exhaust from the fuel cell, a closed loop energy source is created. The size of the water reservoir will depend on the scale to which the unit is built and the efficiency of the fuel cells (see FIG. 2).

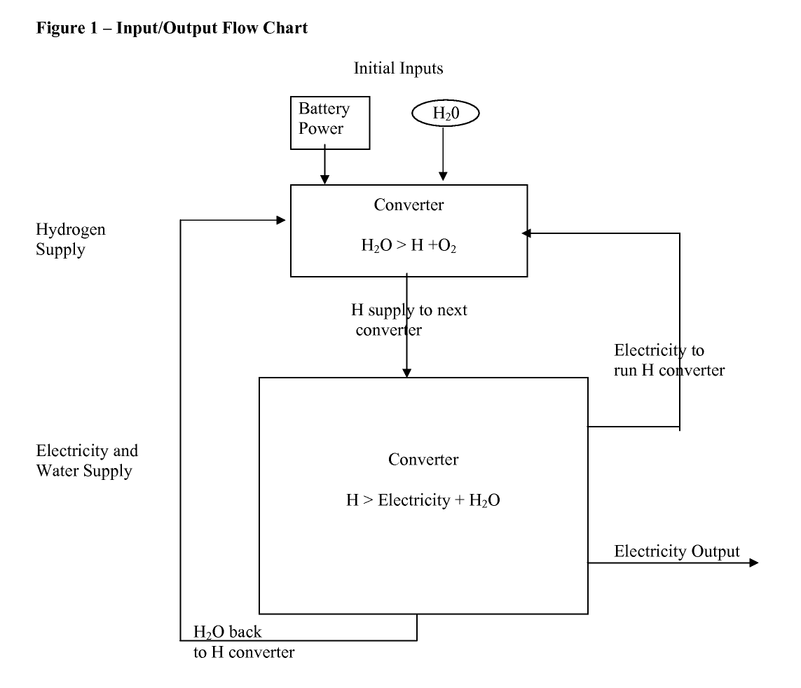

FIG. 1 outlines the main components of the unit and how they interact to create the closed loop. A water reservoir feeds a water-to-hydrogen converter. Hydrogen flows from the converter into a hydrogen fuel cell, or multiple hydrogen fuel cells. Water exhaust from the hydrogen fuel cell(s) is collect into a compartment and is pumped back up into the reservoir that feeds the water-to-hydrogen converter. Electricity from the fuel cell(s) flows in two directions—one electrical pathway runs the water-to-hydrogen converter and the water pump, the other pathway is the electrical output.

A battery is connected to the water-to-hydrogen converter to jump-start or spark the loop. The converter will run on battery power until enough hydrogen is created to fill the fuel cells and maintain the loop. The battery power source is only used for the initial startup of the unit or if the unit is ever turned off and needs to be restarted. A battery power meter will be included to ensure the battery is always available. A long-life battery such as those used in medical equipment is preferred. Battery size is dependent upon the scale to which the unit is built (see FIG. 2).

Some amount of water attrition will occur even in a tightly closed environment. This attrition is estimated to be slight, but varies depending primarily on the efficiency of the hydrogen fuel cell(s). Depending on the size of the water reservoir in the unit and efficiency of the fuel cells, additional water may need to be added as infrequently as every 1-5 years. The water reservoir will include an alarm to indicate when it needs additional water, to avoid any interruption in service or it can be hooked directly into a water source and automatically refill as needed.

1. The claim for this invention is the system that results from combining in a contained unit: a water supply, a water-to-hydrogen converter, hydrogen fuel cell(s), and a collection and pumping device that moves the fuel cell exhaust back into the water supply, creating a closed loop energy output source.
a. To operate these systems as a closed-loop system, a temporary power source for the water-to-hydrogen converter must be supplied for use until the hydrogen fuel cell(s) fill, after which the water-to-hydrogen converter and the exhaust water pump run off of a portion of the energy created by hydrogen fuel cell(s) creating a self-sustaining unit and simultaneously provides a larger portion of the energy for output.
b. The size, capacity, output, and use of the unit is flexible within the system specifications and can be varied to meet any individual need for energy, large or small.
